(19) United States
(12) Patent Application Publication
(10) Pub. No.: US 2007/0212492 A1
(43) Pub. Date: Sep. 13, 2007

(54) Method of Manufacturing a Coated Sheet, Coated Sheet, Polarizing Plate, Optical Element and Image Display Device

(75) Inventors: Seiji Kondou, Osaka (JP); Kentarou Yoshida, Osaka (JP); Makoto Fujihara, Osaka (JP); Masahiro Ehara, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, OSAKA (JP)

(21) Appl. No.: 11/659,490

(22) PCT Filed: Jul. 1, 2005
(86) PCT No.: PCT/JP05/12211

§ 371 Date: Feb. 5, 2007

(30) Foreign Application Priority Data
Dec. 13, 2004 (JP) 2004-360020
May 16, 2005 (JP) 2005-142984

(51) Int. Cl. B05D 3/12; B05D 3/02

(52) U.S. Cl. 427/355; 427/372.2

(57) ABSTRACT

A method for producing a coated sheet which involves an application step of applying a fluid containing a resin material and a solvent on a traveling base film continuously, and a drying step of drying a coating film applied on the base film in the above application step, wherein the above application fluid has a viscosity of 70 to 8,000 mPa sec, and the fluctuation rate for the speed of the traveling of the above base film is controlled to 3.0% or less. The above method can be suitably employed for forming a coating film being free from the failure in its appearance and having a uniform thickness.

### FIELD OF THE INVENTION

The present invention relates mainly to a method of manufacturing a coated sheet that can be used for such as an optical element and an image display device.

### BACKGROUND OF THE INVENTION

A liquid crystal display device that has great advantages of low-profile, light-weight, and low power consumption is used as a display device of an office automation equipment such as a TV set and a personal computer. A liquid crystal display device currently used includes optical functional layers, such as a liquid crystal layer for producing a retardation film, a hard coat layer for protection of the surface, and a surface treating coat such as an antireflection coat. These optical functional layers each are to be formed with a thin coating layer along with the advance of the optical performance; however when, for example, these optical functional layers each are formed with a coating layer having an uneven thickness or the like, an image display device (e.g., a liquid crystal display device) using this may have a deteriorated display performance.

Meanwhile, the optical functional layers each are manufactured by applying a coating liquid, which is prepared by dissolving a resin or the like having an optical function in a solvent, onto a substrate film and subjecting it to a drying step or the like, thus forming a coating layer on the substrate film. As a method of applying the coating liquid, various methods such as a slot die method, a reverse photogravure coating method, and a micro photogravure method, are adopted (e.g., Patent Document 1).

In recent years, with the advance of the optical function, it is necessary to provide a manufacturing method that can improve the evenness of a coating layer, which layer giving an optical function.

In general, when a coating layer with an even thickness of not more than several μm is to be coated, a coating liquid is set to have a low viscosity of not more than several tens mPa·s so as to utilize a leveling effect or the like and thus carry out a film coating operation.

However, in a case where a coating liquid having a low viscosity is used, resin flow occurs locally on a substrate film by the coating liquid applied thereon during the shift from the application step, in which the coating liquid is applied onto the substrate film, to the drying step, and when the resin is cured with resin flow remained, bright spots due to repellent action on the coated surface, interference unevenness due to the difference in thickness of a resin layer at local areas, uneven retardation or the like may occur, which causes appearance defect, posing a problem of making it difficult to form a coating layer on a substrate film without appearance defect.

Therefore, there is a demand for a method of manufacturing a coated sheet that allows for the formation of a coating layer of a uniform thickness on a substrate film without appearance defect.

Patent Document 1: Japanese Patent Application Laid-open No. Sho-62-140672.

### SUMMARY OF THE INVENTION

In consideration of the above problem and demand as mentioned above, it is an object of the present invention to provide a method of manufacturing a coated sheet that is capable of forming a coating layer of a uniform thickness on a substrate film without appearance defect.

Means to Solve the Problems

The present inventors made intensive investigations in order to eliminate the problems mentioned above. As a result, they have found that a coating layer of a uniform thickness can be formed on a substrate film by setting the viscosity of a coating liquid to be applied onto the substrate film and the fluctuation rate of the running speed of the substrate film respectively within given ranges. The present invention has thus been achieved.

According to the present invention, there is provided a method of manufacturing a coated sheet, which is characterized in that it involves an application step of applying a coating liquid containing a resin material and a solvent onto a substrate film that is continuously running, and a drying step of drying a coating layer applied onto the substrate film by the application step, in which the viscosity of the coating liquid is from 70 to 8000 mPa·s, and the fluctuation rate of the running speed of the substrate film in the application step is controlled to be not more than 3.0%.

With the viscosity of the coating liquid of from 70 to 8000 mPa·s, resin flow during the shift from the application step to the drying step is suppressed so that it is possible to suppress the occurrence of bright spots due to repellent action, interference unevenness due to the thickness difference, uneven retardation or the like, thus enabling suppressing the occurrence of appearance defect. Furthermore, with the fluctuation rate of the running speed of the substrate controlled to be not more than 3.0%, the uniform thickness of a coating layer is maintained when it is applied even with a relatively high viscosity so that a coating layer can be formed with a uniform thickness on the substrate film.

In the present invention, the coating liquid preferably has a viscosity of from 100 to 2000 mPa·s.

With this method, it is possible to further suppress occurrence of a defect appearance due to resin flow during the shift from the application step to the drying step, as well as preventing occurrence of bubbles of the solvent in the coating layer in a drying operation of the coating layer.

In the present invention, the running speed of the substrate film is preferably from 10 to 300 m/min.

This method enables the coating liquid to be discharged in a stabilized manner so that a coated sheet with a good thickness accuracy can be obtained.

In the present invention, it is preferable to use a die coater as a device for applying the coating liquid onto the substrate film.

The die coater is of a sealed supply system so that the viscosity of the coating liquid is unlikely to be changed in the applying operation, thus achieving the coat application with an improved accuracy.

In the present invention, the die coater has a pair of die lips and at least one of inner leading end portions thereof is preferably rounded (subjected to R-processing) with a radius of from 0.2 to 1.0 mm.

With this method, the coating liquid is discharged through the leading end portions of the die lips in a stabilized manner so that a coated sheet having a thickness formed with a good accuracy can be obtained.

In the present invention, the coating layer after it has been dried preferably has a thickness of not more than 30 μm.

With this method, it is possible to prevent drying unevenness, blisters or the like.

### ADVANTAGES OF THE INVENTION

As described above, according to the method of manufacturing a coated sheet of the present invention, it is possible to form a coating layer having a uniform thickness on a substrate film without a defect appearance.

The coated sheet manufactured by the method of the present invention, which does not have a defect appearance due to the thickness difference, is useful in forming a film for optical use.

### BRIEF DESCRIPTION OF THE DRAWINGS

FIG. 1 is a cross sectional view of a die coater that has a portion subjected to R-processing on the upstream side of a running substrate film.

FIG. 2 is a cross sectional view of a die coater that has a portion subjected to R-processing on the downstream side of a running substrate film.

FIG. 3 is a cross sectional view of a die coater that has leading inner ends both subjected to R-processing.

FIG. 4 is a cross sectional view illustrating the shape of a die coater used in Example 1.

FIG. 5 is a photograph of a coated sheet in plan obtained in Example 1.

FIG. 6 is a photograph of a coated sheet in plan obtained in Comparative Example 1.

### DESCRIPTION OF THE REFERENCE CODES

1:Die coater

2: Substrate film

3: Die lip

4: R-processed portion

### DETAILED DESCRIPTION OF THE PREFERRED EMBODIMENT

The method of manufacturing a coated sheet of the present invention involves an application step of applying a coating liquid containing a resin material and a solvent onto a substrate film that is continuously running, and a drying step of drying a coating layer applied onto the substrate film by the application step, in which the viscosity of the coating liquid is from 70 to 8000 mPa·s, and the fluctuation rate of the running speed of the substrate film in the application step is controlled to be not more than 3.0%.

Now, the description will be made for a substrate film, a resin material, a solvent and the like used in the coated sheet manufacturing method of the present invention.

As long as a material for the substrate film has a certain degree of wettability with respect to a coating liquid, it is not necessary limited to a specific material. For this, a transparent substrate film, a glass plate of various types and the like can be cited. When an optical functional layer is to be formed by a coating liquid, it is preferable to use a transparent substrate film as a substrate film.

As an example of the transparent substrate film, it can be cited a film made of a transparent polymer, such as polyester polymers, such as polyethylene terephthalate and polyethylene naphthalate; cellulose polymers, such as cellulose diacetate and cellulose triacetate; polycarbonate polymers; and acrylic polymers, such as polymethyl methacrylate.

It is also possible to cite a film made of a transparent polymer, such as styrene polymers, such as polystyrene and acrylonitrile-styrene copolymer; olefin polymers, such as polyethylene, polypropylene, polyolefin having a cyclo or norbornene structure and ethylene-propylene copolymer; vinyl chloride polymers; and amide polymers, such as Nylon and aromatic polyamide.

It can be also cited a film made of a transparent polymer, such as imide polymers; sulfone polymers; polyether-sulfone polymers, polyether-ether-ketone polymers; polyphenylene sulfide polymers; vinyl alcohol polymers; vinylidene chloride polymers; vinyl butyral polymers; allylate polymers; polyoxymethylene polymers; epoxy polymers; and blends of these polymers. Especially in optical property, a film having small birefringence is suitably used.

As a transparent substrate film, cellulose polymers, such as cellulose triacetate is preferable and a cellulose triacetate film is especially preferable from the view point of the light polarizing property and endurance.

As a substrate film, it can be cited polymer films disclosed in Japanese Patent Application Laid-open No. 2001-343529 (WO 01/37007), which contains such as compositions of thermoplastic resins substituted and/or non-substituted imido group in side chain and thermoplastic resins having substituted and/or non-substituted phenyl group and nitryl group in side chain. As an example, it can be cited a film of a resin composition containing an alternating copolymer of isobutene and N-methylene maleimide and an acrylonitrile-styrene copolymer.

The thickness of the substrate film can be properly determined according to needs and circumstances, and is generally about from 10 to 500 μm, preferably from 20 to 300 μm, and more preferably from 30 to 200 μm from the view point of workability, such as strength and handling property, and thin film characteristics.

Any coating liquids may be used in the present invention, as long as they can each form a coating layer on a substrate film, in which a resin material and a solvent, of the coating liquid can be properly selected according to the function of the coated layer to be obtained.

As an example of the resin material, it can be cited a polymer such as polyamide, polyimide, polyester, polyetherketone, polyamide-imide or polyester-imide because of its excellent heat resistance, chemical resistance, transparency and hardness. It may be possible to use one of these polymers alone or a mixture of two or more polymers having different functional groups, for example, a mixture of polyetherketone and polyamide. Among these polymers, polyimide is especially preferable because of its high transparency, high orientation and high stretchability.

The molecular weight of each of the aforesaid polymers is not necessarily limited, but for example the weight-average molecular weight (Mw) is preferably in the range of from 1,000 to 1,000,000 and more preferably in the range of from 2,000 to 500,000.

The polyimide is preferably of the type that has a high in-plane orientation and is soluble in organic solvent. Specifically, a polymer that includes a condensed polymer of 9,9-bis(aminoaryl)fluorene and an aromatic tetracarboxylic acid anhydride, having at least one repeat unit of the following formula (1), as disclosed in Japanese Patent Publication Tokuhyo 2000-511296.

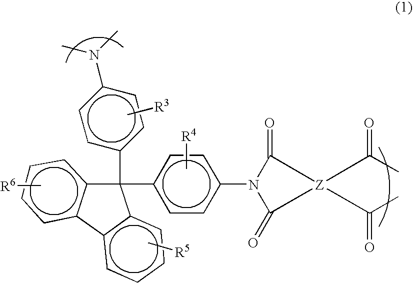

In the above formula (1), R³-R⁶ each are at least one substituent independently selected from the group consisting of hydrogen, halogen, phenyl or phenyl substituted with 1 to 4 halogen atoms or a C₁₋₁₀ (carbon numbers of 1-10) alkyl group, and a C₁₋₁₀ alkyl group, and R³-R⁶ each preferably are at least one substituent independently selected from the group consisting of halogen, phenyl or phenyl substituted with 1 to 4 halogen atoms or a C₁₋₁₀ alkyl group, and a C₁₋₁₀ alkyl group.

In the above formula (1), Z is for example a tetravalent aromatic group having 6 to 20 carbon atoms, and preferably a pyromellitic group, a polycyclic-aromatic group, derivatives of a polycyclic-aromatic group, or a group represented by the following formula (2).

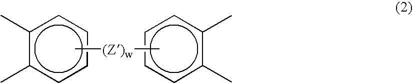

In the above formula (2), Z′ represents for example a covalent bond, a C(R⁷)₂ group, a CO group, an O atom, an S atom, an S02 group, an Si(C₂H₅)₂ group, or an NR⁸ group, and when there are plural Z's, they may be the same or different. W represents an integer from 1 to 10. R⁷ each are independently hydrogen or C(R⁹)₃. R⁸ is hydrogen, a C₁₋₂₀ alkyl group, or a C₆-₂₀ aryl group, and when it is plural, they may be the same or different. R⁹ each are independently hydrogen, fluorine or chlorine.

An example of the polycyclic-aromatic group includes a tetravalent group derived from naphthalene, fluorene, benzofluoren or anthracene. Examples of the derivatives of the polycyclic-aromatic group include the polycyclic-aromatic group substituted with at least one selected from the group consisting of a C₁₋₁₀ alkyl group, its fluorinated derivatives, and halogens such as F and Cl.

Further examples of the polymer include homopolymer having a repeat unit represented by the following formula (3) or (4), or polyimide having a repeat unit represented by the following forumula (5), as described Japanese Patent Publication Tokuhyo Hei-8-511812. A polyimide of the following formula (5) is a preferable form of a homopolymer of the formula (3).

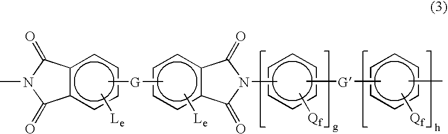

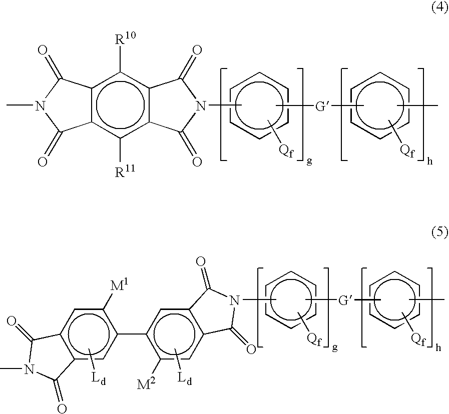

In the formulae (3) to (5), G and G′ each represent a covalent bond, or a group independently selected from the group consisting of, for example, a CH2 group, a C(CH₃)₂ group, a C(CF₃)₂ group, a C(CX3)₂ group (herein, X represent halogen), a CO group, an O atom, an S atom, an SO₂ group, an Si(CH2CH₃)₂ group, and an N(CH₃) group. They may be the same or different.

In the formulae (3) and (5), L represents a substituent, and d and e each represent the number of the corresponding substituent. L represents for example halogen, a C₁₋₃ alkyl group, a halogenated C₁₋₃ alkyl group, a phenyl group, or a substituted phenyl group, and when there are plural Ls, they may be the same or different. Examples of the substituted phenyl group include a substituted phenyl group having at least one substituent selected from the group consisting of halogen, a C₁₋₃ alkyl group, and a halogenated C₁₋₃ alkyl group. Examples of the halogen include fluorine, chlorine, bromine and iodine. d represents an integer from 0 to 2, and e represents an integer from 0 to 3.

In the above formulae (3) to (5), Q represents a substituent and f represents the number of substitutions thereof. An example of Q includes an atom or group selected from the group consisting of hydrogen, halogen, an alkyl group, a substituted alkyl group, a nitro group, a cyano group, a thioalkyl group, an alkoxy group, an aryl group, a substituted aryl group, an alkyl ester group, and a substituted alkyl ester group. When there are plural Qs, they may be the same or different. Examples of the halogen include fluorine, chlorine, bromine and iodine. An example of the substituted alkyl group includes a halogenated alkyl group.

An example of the substituted aryl group includes a halogenated aryl group. In the formulae, f represents an integer from 0 to 4, and g and h respectively represent an integer from 0 to 3 and an integer from 1 to 3, in which g and h each are preferably greater than 1.

In the formula (4), R¹⁰ and R¹¹ each represent a group independently selected from the group consisting of hydrogen, halogen, a phenyl group, a substituted phenyl group, an alkyl group and a substituted alkyl group.

Among them, R^{10 and R}¹¹ each are preferably a halogenated alkyl group independently selected therefrom.

In the formula (5), M¹ and M² may be the same or different, and examples of them include halogen, a C₁₋₃ alkyl group, a C₁₋₃ halogenated alkyl group, a phenyl group or a substituted phenyl group.

Examples of the halogen include fluorine, chlorine, bromine and iodine.

An example of the substituted phenyl group includes a substituted phenyl group having at least one substituent selected from the group consisting of halogen, a C₁₋₃ alkyl group, and a C₁₋₃ halogenated alkyl group.

An example of polyimide represented in the formula (3) includes the one represented by the following formula (6).

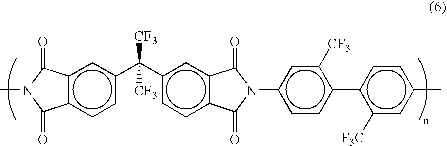

An example of the polyimide includes a copolymer prepared by appropriate copolymerization of dianhydride or diamine other than the aforesaid chemical architecture (repeat unit).

An example of the dianhydride includes aromatic tetracarboxilic dianhydride.

Examples of the aromatic tetracarboxilic dianhydride include pyromellitic dianhydride, benzophenon tetracarboxylic dianhydrade, naphthalene tetracarboxylic dianhydride, heterocyclic aromatic tetracarboxylic dianhydride, and 2,2′-substituted biphenyl tetracarboxylic dianhydride.

Examples of the pyromellitic dianhydride include non-substituted pyromellitic dianhydride, 3,6-diphenyl pyromellitic dianhydride, 3,6-bis(trifluoromethyl)pyromellitic dianhydride, 3,6-dibromopyromellitic dianhydride, and 3,6-dichloropyromellitic dianhydride. Examples of the benzophenone tetracarboxylic dianhydride include 3,3′,4,4′-benzophenone tetracarboxylic dianhydride, 2,3,3′,4′-benzophenone tetracarboxylic dianhydride and 2,2′,3,3′-benzophenone tetracarboxylic dianhydride. Examples of the naphthalene tetracarboxylic dianhydride include 2,3,6,7-naphthalene-tetracarboxylic dianhydride, 1,2,5,6-naphthalene-tetracarboxylic dianhydride, and 2,6-dichloro-naphthalene-1,4,5,8-tetracarboxylic dianhydride. Examples of the heterocyclic aromatic tetracarboxylic dianhydride include thiophene -2,3,4,5-tetracarboxylic dianhydride, pyrazine-2,3,5,6-tetracarboxylic dianhydride and pyridine-2,3,5,6-tetracarboxylic dianhydride.

Examples of the 2,2′-substituted biphenyl tetracarboxylic dianhydride include 2,2′-dibromo-4,4′,5,5′-biphenyl tetracarboxylic dianhydride, 2,2′-dichloro-4,4′,5,5′-biphenyl tetracarboxylic dianhydride and 2,2′-bis(trifluoromethyl)-4,4′,5,5′-biphenyl tetracarboxylic dianhydride.

Other examples of the aromatic tetracarboxylic dianhydride may include 3,3′,4,4′-biphenyl tetracarboxylic dianhydride, bis(2,3-dicarboxyphenyl)methane dianhydride, bis(2,5,6-trifluoro-3,4-dicarboxyphenyl)methane dianhydride, 2,2-bis(3,4-dicarboxyphenyl)-1,1,1,3,3,3-hexafluoropropane dianhydride, 4,4′-(3,4-dicarboxyphenyl)-2,2-diphenylpropane dianhydride, bis(3,4-dicarboxyphenyl)ether dianhydride, 4,4′-oxydiphthalic dianhydride, bis(3,4-dicarboxyphenyl)sulfonic dianhydride (3,3′,4,4′-diphenylsulfone tetracarboxylic dianhydride), 4,4′-[4,4′-isopropylidene-di(p-phenyleneoxy)]bis(phthalic dianhydride), N,N-(3,4-dicarboxyphenyl)-N-methylamine dianhydride and bis(3,4-dicarboxyphenyl)diethylsilane dianhydride.

Among the above, the aromatic tetracarboxylic dianhydride preferably is 2,2′-substituted biphenyl tetracarboxylic dianhydride, more preferably is 2,2′-bis(trihalomethyl)-4,4′,5,5′-biphenyl tetracarboxylic dianhydride, and further preferably is 2,2′-bis(trifluoromethyl)-4,4′,5,5′-biphenyl tetracarboxylic dianhydride.

The aforesaid diamine may be, for example, aromatic diamine. Specific examples thereof include benzenediamine, diaminobenzophenone, naphthalenediamine, heterocyclic aromatic diamine and other aromatic diamines.

The benzenediamine may be, for example, diamine selected from the group consisting of benzenediamines such as o-, m- or p-phenylenediamine, 2,4-diaminotoluene, 1,4-diamino-2-methoxybenzene, 1,4-diamino-2-phenylbenzene and 1,3-diamino-4-chlorobenzene. Examples of the diaminobenzophenone include 2,2′-diaminobenzophenone and 3,3′-diaminobenzophenone. The naphthalenediamine may be, for example, 1,8-diaminonaphthalene or 1,5-diaminonaphthalene. Examples of the heterocyclic aromatic diamine include 2,6-diaminopyridine, 2,4-diaminopyridine and 2,4-diamino-S-triazine.

Further, other than the above, the aromatic diamine may be 4,4′-diaminobiphenyl, 4,4′-diaminodiphenyl methane, 4,4′-(9-fluorenylidene)-dianiline, 2,2′-bis(trifluoromethyl)-4,4′-diaminobiphenyl, 3,3′-dichloro-4,4′-diaminodiphenyl methane, 2,2′-dichloro-4,4′-diaminobiphenyl, 2,2′,5,5′-tetrachlorobenzidine, 2,2-bis(4-aminophenoxyphenyl)propane, 2,2-bis(4-aminophenyl)propane, 2,2-bis(4-aminophenyl)-1,1,1,3,3,3-hexafluoropropane, 4,4′-diamino diphenyl ether, 3,4′-diamino diphenyl ether, 1,3-bis(3-aminophenoxy)benzene, 1,3-bis(4 aminophenoxy)benzene, 1,4-bis(4-aminophenoxy)benzene, 4,4′-bis(4-aminophenoxy)biphenyl, 4,4′-bis(3-aminophenoxy)biphenyl, 2,2-bis [4-(4-aminophenoxy)phenyl]propane, 2,2-bis [4-(4-aminophenoxy)phenyl]-1,1,1,3,3,3,-hexafluoropropane, 4,4′-diamino diphenyl thioether or 4,4′-diaminodiphenylsulfone.

The polyetherketone as the aforesaid resin material may be, for example, polyaryletherketone represented by the following formula (7), which is disclosed in Japanese Patent Application Laid-open No. 2001-49110.

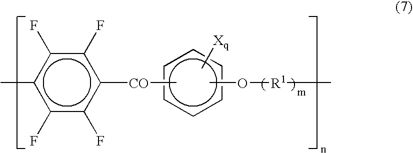

In the above formula (7), X represents a substituent, and q represents the number of the substitutions. X is, for example, a halogen atom, a lower alkyl group, a halogenated alkyl group, a lower alkoxy group or a halogenated alkoxy group, and when there are plural Xs, they may be the same or different.

The halogen atom may be, for example, a fluorine atom, a bromine atom, a chlorine atom or an iodine atom, and among these, a fluorine atom is preferable. The lower alkyl group preferably is a C₁₋₆ lower straight alkyl group or a C₁₋₆ lower branched alkyl group and more preferably is, for example, a C₁₋₄ straight or branched chain alkyl group. More specifically, it is preferably a methyl group, an ethyl group, a propyl group, an isopropyl group, a butyl group, an isobutyl group, a sec-butyl group or a tert-butyl group, and particularly preferably a methyl group or an ethyl group. The halogenated alkyl group may be, for example, a halide of the aforesaid lower alkyl group such as a trifluoromethyl group. The lower alkoxy group is preferably a C₁₋₆ straight or branched chain alkoxy group and more preferably is, for example, a C₁₋₄ straight or branched chain alkoxy group. More specifically, it is further preferably a methoxy group, an ethoxy group, a propoxy group, an isopropoxy group, a butoxy group, an isobutoxy group, a sec-butoxy group or a tert-butoxy group, and particularly preferably a methoxy group or an ethoxy group. The halogenated alkoxy group may be, for example, a halide of the aforesaid lower alkoxy group such as a trifluoromethoxy group.

In the above formula (7), q is an integer from 0 to 4. In the formula (7), it is preferable that q=0 and a carbonyl group and an oxygen atom of an ether that are bonded to both ends of a benzene ring are present at para positions.

Also, in the above formula (7), R¹ is a group represented by the following formula (8), and m is an integer of 0 or 1.

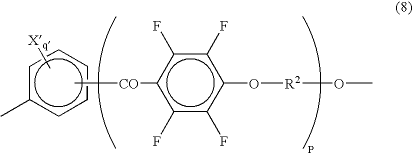

In the above formula (8), X′ is a substituent and is, for example, the same as X in the formula (7). In the formula (8), when there are plural X's, they may be the same or different. q′ represents the number of the substitutions of the X′ and is an integer from 0 to 4, preferably, q′=O. In addition, p is an integer of 0 or 1.

In the formula (8), R² represents a divalent aromatic group. This divalent aromatic group may be, for example, an o-, m- or p-phenylene group or a divalent group derived from naphthalene, biphenyl, anthracene, o-, m- or p-terphenyl, phenanthrene, dibenzofuran, biphenyl ether or biphenyl sulfone. In these divalent aromatic groups, hydrogen that is bonded directly to the aromatic may be substituted with a halogen atom, a lower alkyl group or a lower alkoxy group. Among them, the R² preferably is an aromatic group selected from the group consisting of the formulae (9) to (15) below.

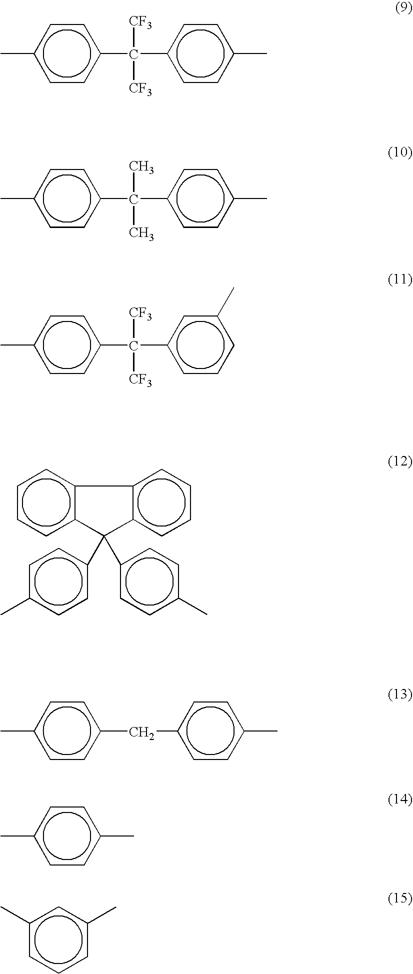

In the above formula (7), the R¹ is preferably a group represented by the following formula (16), in which R² and p are equivalent to those in the aforesaid formula (8).

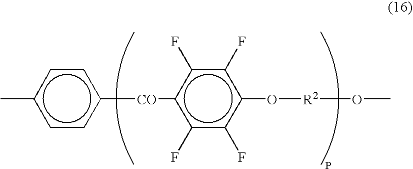

Furthermore, in the formula (7), n represents a degree of polymerization ranging for example, from 2 to 5,000 and preferably from 5 to 500. The polymerization may be composed of repeating units having the same structure or different structures. In the latter case, the polymerization form of the repeating units may be a block polymerization or a random polymerization.

Moreover, it is preferable that an end on a p-tetrafluorobenzoylene group side of the polyaryletherketone represented by the formula (7) is fluorine and an end on an oxyalkylene group side thereof is a hydrogen atom. Such a polyaryletherketone can be represented by the general formula (17) below. In the formula below, n represents a degree of polymerization as in the formula (7).

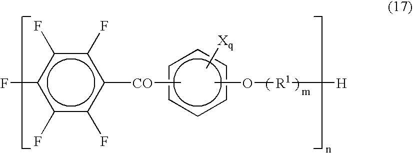

Specific examples of the polyaryletherketone represented by the formula (7) may include those represented by the formulae (18) to (21) below, in which n represents a degree of polymerization as in the formula (7).

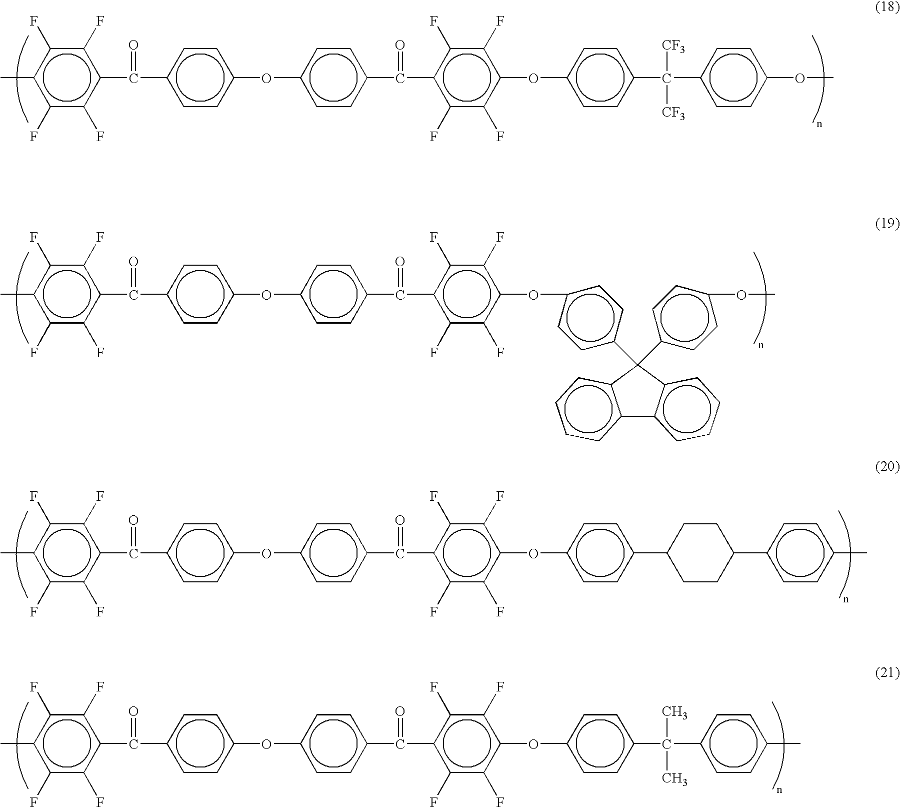

Other than the above, the polyamide or polyester as the aforesaid resin material may be, for example, polyamide or polyester described by Japanese Patent Publication Tokuhyo Hei-10-508048, and their repeating units can be represented by the general formula (22) below.

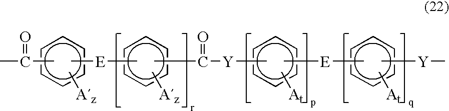

In the above formula (22), Y is O or NH. E is, for example, a covalent bond, or at least one group selected from the group consisting of a C₂ alkylene group, a halogenated C₂ alkylene group, a CH₂ group, a C(CX₃)₂ group (herein X is halogen or hydrogen), a CO group, an O atom, an S atom, an SO₂ group, an Si(R)₂ group and an N(R) group, and Es may be the same or different. In the aforesaid E, R is at least one of a C₁₋₃ alkyl group and a halogenated C₁₋₃ alkyl group and presents at a meta position or a para position with respect to a carbonyl functional group or a Y group.

Further, in the above formula (22), A and A′ are substituents, and t and z respectively represent the numbers of the substitutions. Additionally, p is an integer from 0 to 3, q is an integer from 1 to 3, and r is an integer from 0 to 3.

The aforesaid A is selected from the group consisting of, for example, hydrogen, halogen, a C₁₋₃ alkyl group, a C₁₋₃ halogenated alkyl group, an alkoxy group represented by OR (wherein R is the group defined above), an aryl group, a substituted aryl group by halogenation or the like, a C₁₋₉ alkoxycarbonyl group, a C₁₋₉ alkylcarbonyloxy group, a C₁₋₁₂ aryloxycarbonyl group, a C₁₋₁₂ arylcarbonyloxy group and a substituted derivative thereof, a C₁₋₁₂ arylcarbamoyl group, and a C₁₋₁₂ arylcarbonylamino group and a substituted derivative thereof. When there are plural As, they may be the same or different. The aforesaid A′ is selected from the group consisting of, for example, halogen, a C₁₋₃ alkyl group, a halogenated C₁₋₃ alkyl group, a phenyl group and a substituted phenyl group and when there are plural A's, they may be the same or different. A substituent on a phenyl ring of the substituted phenyl group can be, for example, halogen, a C₁₋₃ alkyl group, a C₁₋₃ halogenated alkyl group or a combination thereof. The t is an integer from 0 to 4, and the z is an integer from 0 to 3.

Among the repeating units of the polyamide or polyester represented by the formula (22) above, the repeating unit represented by the general formula (23) below is preferable.

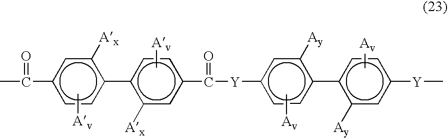

In the formula (23), A, A′ and Y are those defined by the formula (22), and v is an integer from 0 to 3, preferably is an integer from 0 to 2. Although each of x and y is 0 or 1, not both of them are 0.

The polyester may be the one having a repeating unit represented by the general formulae (24) and (25) below.

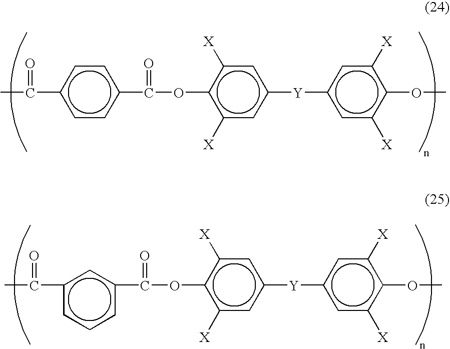

In the formulae (24) and (25), X and Y each represent a substituent. The X is selected from the group consisting of hydrogen, chlorine and bromine. The Y is selected from the group consisting of the formulae (26), (27), (28) and (29) below.

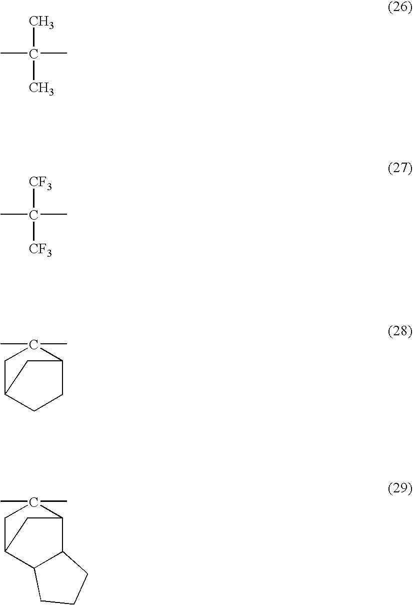

The polyester may be a copolymer combined with polyester represented in the general formulae (24), (25).

The solvent for dissolving the resin material is not particularly limited as long as it can dissolve the resin material and does not excessively eat into the substrate film, and can be selected suitably according to the resin material and the substrate film to be used. Examples thereof include halogenated hydrocarbons, such as chloroform, dichloromethane, carbon tetrachloride, dichloroethane, tetrachloroethane, trichloroethylene, tetrachloroethylene, chlorobenzene and o-dichlorobenzene; phenols, such as phenol and parachlorophenol; aromatic hydrocarbons, such as benzene, toluene, xylene, methoxybenzene and 1,2-dimethoxybenzene; acetone; ethyl acetate; t-butyl alcohol; glycerin; ethylene glycol; triethylene glycol; ethylene glycol monomethyl ether; diethylene glycol dimethyl ether; propylene glycol; dipropylene glycol; 2-methyl-2,4-pentanediol; ethyl cellosolve; butyl cellosolve; 2-pyrrolidone; N-methyl-2-pyrrolidone; pyridine; triethylamine; dimethylformamide; dimethylacetoamide; acetonitrile; butyronitrile; methyl isobutyl ketone; methylethylketone; cyclopentanone; and carbon disulfide.

Among the aforesaid solvents, methylisobutylketone is particularly preferable because it has an excellent solubility for a resin composition and does not eat into a substrate film.

These solvents may be used alone or in combination of two or more according to needs and circumstances.

Now, the description will be made for the method of manufacturing a coated sheet of the present invention.

First, the resin material is mixed with the solvent and a coating liquid is prepared to have a given viscosity. The viscosity of the coating liquid is from 70 to 8000 mPa·s, preferably from 100 to 2000 mPa·s and more preferably from 150 to 500 mPa·s.

With the viscosity of the coating liquid being less than 70 mPa·s, resin flow occurs during the shift from the application step to the drying step, a defect appearance with bright spots due to repellent action, interference unevenness due to the uneven thickness, uneven retardation, drying spots or the like may be caused.

With the viscosity of the coating liquid being more than 8000 mPa·s, it is not possible to form a coating layer with a uniform thickness, due to even slight fluctuation in running speed. Further, there may be caused a problem in that bubbles of a solvent are caused in the coating layer during drying of the coating layer, and a coating layer having a thickness of about several tens μm is difficult to be formed.

The viscosity of the coating liquid is measured by a method described in Examples.

The application step is meant a step of coating a prepared coating liquid onto a substrate film that is being continuously running.

A device or mechanism used for coating a coating liquid onto a substrate film is not necessarily limited to a specific one, and a generally used device or mechanism can be used.

Examples of the device or mechanism include a roll coater, a die coater and a curtain coater.

Among them, a die coater that is of a measuring type and a sealed supply system, capable of blocking evaporation of solvent, is used, considering the application accuracy and the like. It is possible to prevent the fluctuation of viscosity of a coating liquid in the application step by using a die coater of a sealed supply system that is capable of blocking evaporation of a solvent.

The die coater has a pair of die lips disposed facing each other and extending in a widthwise direction of a substrate film, and is designed to be capable of discharging a coating liquid through a leading end (i.e., inner leading end) between both the die lips.

The width of a leading end of the die lips (distance between the die lips) is from 0.1 to 10.0 mm, preferably from 0.1 to 5.0 mm and more preferably from 0.5 to 3.0 mm.

With the width of the leading end of the die lips being less than 0.1 mm, there may be caused a problem in processing accuracy when preparing a die, and a problem of causing a crack in the leading end portion of the die lips during the application step.

With the width of the leading end being more than 10.0 mm, a flow of a coating liquid through the leading end of the die lips becomes unstabilized, which may pose a problem of causing appearance defect to an obtained coated sheet.

An inner leading end portion of at least one of the die lips of the die coater used is rounded or subjected to R-processing.

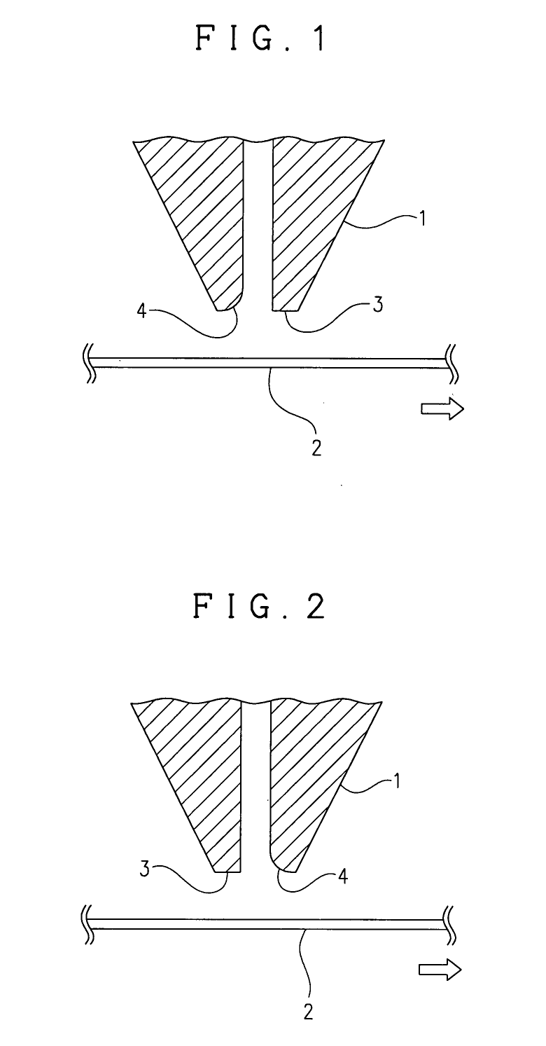

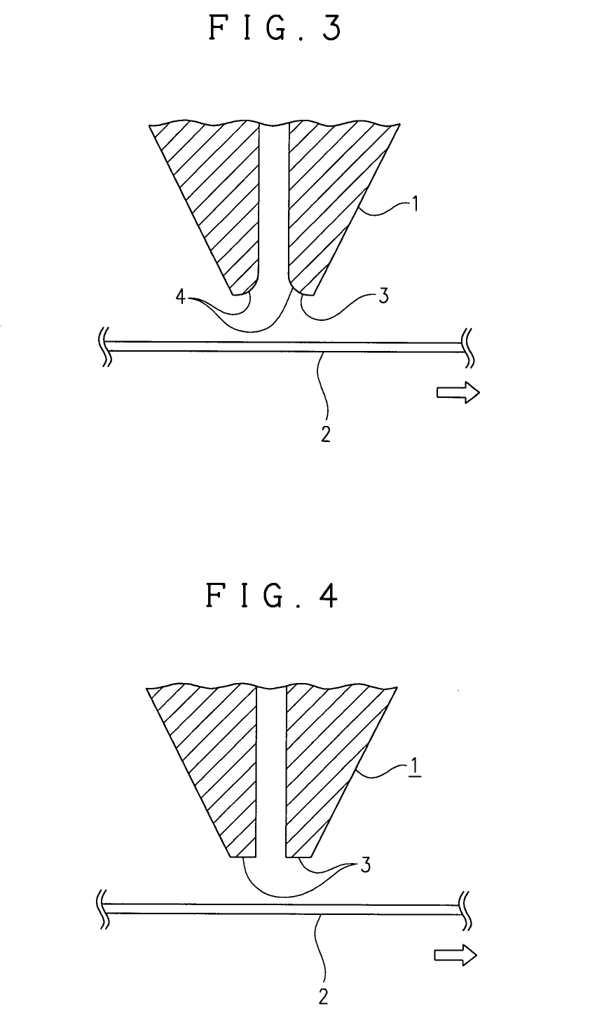

As an example of the die coater (1), it can be cited a die coater in which R-processing (4) is applied to an inner leading end portion of a die lip (3) on the upstream side of a substrate film (2) that runs in a direction represented specifically by an arrow of FIG. 1, a die coater in which R-processing (4) is applied to an inner leading end portion of the die lip (3) on the downstream side of the substrate film (2) that runs in a direction represented by an arrow of FIG. 2, or a die coater in which R-processing (4) is applied to both the inner leading end portions, as illustrated in FIG. 3.

Each may be rounded (subjected to R-processing) with a radius of from 0.2 to 1.0 mm, and preferably from 0.4 to 0.8 mm.

When the radius for the R processing is in a range of from 0.2 to 1.0 mm, the discharging of a coating liquid through the leading end portions of the die lips is stabilized, and it is possible to provide an advantage that a coated sheet can be obtained with a good thickness accuracy.

The substrate film continuously runs and the running speed thereof is set to be within a range of from 10 to 300 m/min, preferably from 10 to 100 m/min, and more preferably from 10 to 50 m/min.

When the running speed of the substrate film is within a range of from 10 to 300 m/min, the discharging of a coating liquid through the leading end of the die lips become stabilized, so that it is possible to provide an advantage that a coated sheet can be obtained with a good thickness accuracy.

The fluctuation rate of the running speed of the substrate film is controlled to be not more than 3.0%, preferably controlled to be not more than 1.0%, and more preferably controlled to be not more than 0.7%.

With the fluctuation rate of the running speed controlled to be not more than 3.0%, a coating liquid is applied onto the substrate film in a stabilized condition and thus it is possible to provide an advantage that a coated sheet is obtained with a uniform thickness.

When the fluctuation rate of the running speed of the substrate film exceeds 3.0%, a coating liquid is applied onto the substrate film in an unstabilized condition, which poses a problem of causing unevenness in the widthwise direction (streaky coating unevenness in the widthwise direction).

The fluctuation rate of the running speed of the substrate film is measured by the method described in the Examples. The running speed is meant in the present invention an average running speed, which is measured by the same method as that for determining the fluctuation rate of the running speed.

In order to control the fluctuation rate of the running speed of the substrate film to be not more than 3.0%, the fluctuation rate of the running speed of the substrate film is first determined by the method described in the Examples. Then, the fluctuation rate of the running speed is controlled to be not more than 3.0% by, for example, controlling the rotational speed of a driving roll for running the substrate film, controlling the tensile force of a belt for driving the driving roll, adjusting the angle at which the driving roll contacts the substrate film, or adjusting the friction force between the driving roll and the substrate film by applying a surface treatment to the driving roll. These adjustments may be made independently of each other, or may be totally made.

As a method of drying a coating liquid applied onto the substrate film, a known method, such as a method of blowing dry air from the time immediately after the application step, is used. Since the coating liquid has a high viscosity of from 70 to 8000 mPa·s, liquid flow is less likely caused even by blowing dry air thereof, so that the drying speed can be increased and hence the manufacturing efficiency can be greatly increased.

A coated sheet manufactured by the coated sheet manufacturing method of the present invention has excellent characteristics capable of eliminating various deficiencies such as appearance defect with bright spots due to repellent action on the coated surface, interference unevenness due to the uneven thickness, uneven retardation or the like.

According to the coated sheet manufacturing method of the present invention, it is possible to appropriately adjust the thickness of the coating layer formed and dried on the substrate film by adjusting the amount of a coating liquid to be applied onto the substrate film.

In the coated sheet manufacturing method, the thickness of the coating layer when it is dried is not more than 30 μm, preferably not more than 10 μm and more preferably not more than 5 μm. When the dried thickness exceeds 30 μm, drying unevenness, blisters and the like may be caused during the drying step, so that it is difficult to keep the even coat thickness.

According to the coated sheet manufacturing method of the present invention, the aforesaid coat can be used for an optical functional layer having an optical function, and appropriately used especially when an optical functional layer having a dried coat thickness of not more than 30 μm is formed.

In the coated sheet manufacturing method, it is possible to obtain a coated sheet having a thin and even optical functional layer.

Examples of the optical functional layer include a hard coat layer, an antireflection layer, a retardation layer and an optical compensation layer.

Various transparent resin may be used for forming a hard coat layer, as long as they have an excellent hard coat property (those exhibiting a hardness of H or higher in the pencil hardness test according to JIS K5400), a sufficient strength and an excellent light transmittance. For example, it can be cited a thermosetting resin, a thermoplastic resin, a UV-curing resin, an EB-curing resin and a two-component resin. Among them, a UV-curing resin is preferably used. Examples of the UV-curing resin include various resins, such as a polyester resin, an acrylic resin, an urethane resin, an amid resin, a silicone resin and an epoxy resin, as well as a UV-curable monomer, oligomer or polymer. Examples of the UV-curable resin preferably used include monomer or oligomer having a UV polymerizable functional group, especially two or more UV polymerizable functional groups and more especially from three to six UV polymerizable functional groups. The UV-curable resin may be mixed with an ultraviolet-polymerization initiator.

The hard coat layer may contain electrically-conductive fine grains, examples of which include metal fine-grains, such as aluminium, titanium, tin, gold and silver, and ultra fine grains, such as ITO (indium oxide/tin oxide) and ATO (antimony oxide/tin oxide). It is preferable that a mean diameter of grains of the conductive ultra fine grains is usually about 0.1 μm or less. Ultra fine grains of metals or metal oxides having a high refractive index may be added into a hard coat layer to adjust a high refractive index. Examples of ultra fine grains having a high refractive index include ultra fine grains of metal oxides, such as TiO₂, SnO₂, ZnO₂, ZrO₂, aluminium oxide, and zinc oxide. It is preferable that a mean diameter of grains of the ultra fine grains is usually about 0.1 μm or less.

Moreover, antiglare property may be given to a hard coat layer by dispersing inorganic or organic fillers having a globular form or an infinite form to give fine roughness surface structures to a front face, and thus antiglare property may be given to the hard coat layer. Antiglare property caused by optical diffusion may be realized by providing roughness surface form to a front face of the hard coat layer. Optical diffusion property is preferable also for reducing reflectance.

As inorganic or organic fillers having a globular form or an infinite form, for example, there may be cited: organic cross-linked or non cross-linked fine-grains comprising various polymers, such as PMMAs (poly methylmethacrylates), polyurethanes, polystyrenes, and melamine resins; inorganic grains, such as glass, silicas, aluminas, calcium oxides, titanias, zirconium dioxides, and zinc oxides; and conductive inorganic particles, such as tin oxides, indium oxides, cadmium oxides, antimony oxides, or compounds thereof. A mean diameter of grains of the aforesaid fillers is from 0.5 to 10 μm, and preferably from 1 to 4 μm. When fine roughness surface structures are formed by fine-grains, an amount of fine-grains used is preferably about from 1 to 30 parts by weight to resins 100 parts by weight.

Additives, such as leveling agents, thixotropy agents, and antistatic agents may be included in formation of a hard coat layer (antiglare layer). In formation of a hard coat layer (antiglare layer), thixotropic agents (silica, mica, etc. having a diameter of grains of 0.1 μm or less) are blended, thereby enabling protruding fine grains to easily form fine roughness structures on a surface of the antiglare layer.

As materials for forming antireflective layers, for example, resin based materials, such as UV-curing acrylic resins; hybrid materials having inorganic fine grains dispersed in resins, such as colloidal silica; and sol-gel materials using metal alkoxides, such as tetra ethoxy silane and titanium tetra ethoxide, etc. may be cited. Compounds including fluoride groups are used for each material in order to give soil resistance to a surface. Low refractive index layer material including a large amount of mineral elements has a tendency to show excellent scratch-proof property, and among them particularly sol-gel materials are preferable. Sol-gel materials may be used after partial condensation reaction.

Perfluoroalkyl alkoxy silanes may be exemplifed as the aforesaid sol-gel materials including fluoride groups. As perfluoroalkyl alkoxy silanes, for example, compounds represented by a general formula: CF₃(CF₂)ₙCH₂CH₂Si(OR)₃ (in which R represents alkyl group with carbon numbers of from 1 to 5, and n represents an integer from 0 to 12) may be cited. Specifically, examples thereof include trifluoro propyl trimethoxy silane, trifluoro propyl triethoxy silane, tridecafluoro octyl trimethoxy silane, tridecafluoro octyl triethoxy silane, heptadecafluoro decyl trimethoxy silane and heptadecafluoro decyl triethoxy silane. Especially, compounds whose n gives 2 to 6 are preferable.

Sols in which silica, alumina, titania, zirconia, magnesium fluorides, ceria, etc. are dispersed in an alcoholic solvent may be added into an antireflective layer. In addition, additives, such as metal salts and metal compounds, may appropriately be blended.

In formation of a retardation layer and an optical compensation layer, for example, polymers, such as polyamide, polyimide, polyester, polyetherketone, polyamide-imide and polyester-imide, those described as the resin materials, may be used. Among these polymers, one kind may be used alone, or they may be used as a mixture of two or more different kinds having different functional groups. Among these polymers, polyimide is especially preferable because of its high transparency, high orientation and high stretchability.

In a case where an optical compensation plate having an optical compensation layer of a polyimide resin on the substrate film is prepared by the coated sheet manufacturing method of the present invention, the thickness of the dried optical compensation layer of the polyimide resin is from 0.5 to 10 μm and preferably from 1 to 6 μm.

In an optical compensation plate having an optical compensation layer of the polyimide resin, it is possible to provide an advantage of improving optical characteristics, such as improving the contrast and suppressing a color shift, in an oblique direction of a liquid crystal cell, when the thickness of the dried optical compensation layer is within a range of from 0.5 to 10 μm.

A coated sheet having an optical functional layer or an optical compensation plate having an optical compensation layer manufactured by the coated sheet manufacturing method of the present invention may be laminated with a polarizing plate.

The lamination of the optical compensation plate having the optical compensation layer with the polarizing plate provides an advantage of improving optical characteristics, such as improving the contrast and suppressing a color shift, in an oblique direction of a liquid crystal cell.

Especially, it is possible to enhance the aforesaid advantage by laminating a polarizing plate with an optical compensation plate that has an optical compensation layer of a polyimide resin having the dried thickness of from 0.5 to 10 μm. That is, on the contrary to a conventional optical compensation layer used in a liquid crystal cell or the like, which has a thickness of 50-100 μm, the optical compensation layer of the present invention is very thin, and specifically has a thickness of from 0.5 to 10 μm, and therefore when incorporated into a liquid crystal cell, it is possible to allow for a low profile and lightweight liquid crystal cell.

A coated sheet having an optical functional layer (e.g., a hard coat layer, an antireflection layer, a retardation layer and an optical compensation layer) manufactured by the coated sheet manufacturing method of the present invention, a laminate of this sheet and a polarizing plate, etc., may be used as an optical element.

This optical element may be used in formation of various image display devices, such as a liquid crystal display and an organic EL display device.

### EXAMPLES

Now, a specific description will be made for the present invention with reference to Examples and Comparative Examples, with no intention to limit the present invention to the following Examples. Various characteristics were measured by the following methods.

(Method of Measuring the Viscosity)

The viscosity was measured by using rheometerRSl manufactured by HAAKE at a liquid temperature of 23° C. and shear velocity of 10[l/s].

(Method of Measuring the Running Speed of a Substrate Film)

The running speed of a substrate film was measured by using a measuring device of laser Doppler type (trade name: Model LS200 LaserSpeed, manufactured by KANOMAX Inc.).

(Method of Measuring the Fluctuation Rate of the Running Speed)

The running speed of a substrate film was plotted on a table by using Model LS200 LaserSpeed for 60 successive seconds, and a maximum value X1, a minimum value X2 and an average value AV (average running speed), of the running speed of the substrate was determined from the table, and the fluctuation rate was calculated by using the following formula (1):
Fluctuation rate (%)={[(X1 −X2)÷AV]÷2}×100 (1)

(Method of Measuring the Thickness of a Coating Layer)

Measurement was made by using a dial gauge manufactured by Ozaki Mfg. Co., Ltd.

### Example 1

A polyimide solution having a viscosity of 200 mPa·s with 10% by weight of polyimide (cf., the following formula (30), weight-average molecular weight (Mw)=140,000) dissolved in methylisobutylketone was prepared.

By the use of a die coater as a coating method, the polyimide solution was applied onto a polyethylene terephthalate film (thickness of 75 μm), which runs at a speed of 20 m/min with a fluctuation rate thereof controlled to 2.7%, and after the coating, dried at 120° C. for three minutes to provide a coated sheet with a coating layer having a thickness of 6 μm.

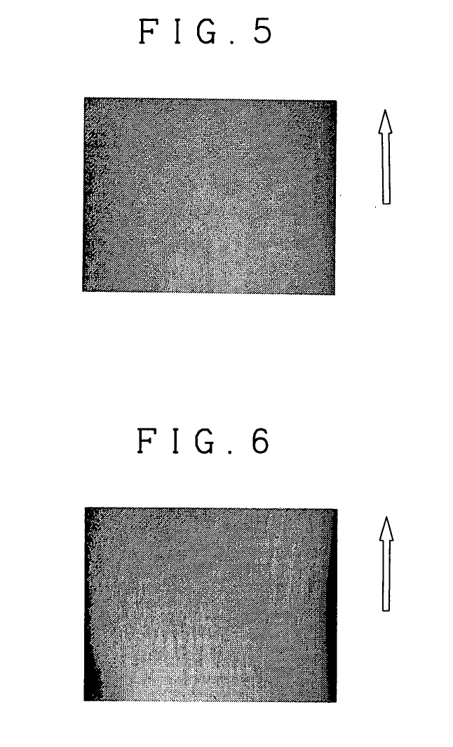

A photograph of a coated sheet in plan thus obtained in Example 1 is illustrated in FIG. 5. An arrow of FIG. 5 represents the running direction of the substrate film.

In the coated sheet obtained in the manner as illustrated in FIG. 5, no interference unevenness due to the uneven thickness was visually observed.

The shape of the die coater used in Example 1 is illustrated in FIG. 4.

The die coater illustrated in FIG. 4 has inner leading end portions both not rounded or subjected to R-processing.

The die coater used has die lips each having a leading end having a width of 0.8 mm.

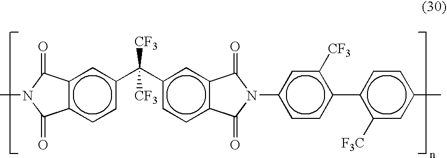

### Example 2

The same procedures as those in Example 1 were carried out, except that a polyimide solution had a viscosity of 500 mPa·s. In the thus obtained coated sheet, no interference unevenness due to the uneven thickness was visually observed, in the same manner as that illustrated in FIG. 5.

### Example 3

The same procedures as those in Example 1 were carried out, except that a polyimide solution had a viscosity of 1000 mPa·s. In the thus obtained coated sheet, no interference unevenness due to the uneven thickness was visually observed, in the same manner as that illustrated in FIG. 5.

### Example 4

The same procedures as those in Example 1 were carried out, except that a polyimide solution had a viscosity of 1500 mPa·s. In the thus obtained coated sheet, no interference unevenness due to the uneven thickness was visually observed, in the same manner as that illustrated in FIG. 5.

### Example 5

The same procedures as those in Example 1 were carried out, except that a polyimide solution had a viscosity of 500 mPa·s., and the running speed was 10 m/min.

In the thus obtained coated sheet, no interference unevenness due to the uneven thickness was visually observed, in the same manner as that illustrated in FIG. 5.

### Example 6

The same procedures as those in Example 1 were carried out, except that a polyimide solution had a viscosity of 500 mPa·s., and the running speed was 150 m/min.

In the thus obtained coated sheet, no interference unevenness due to the uneven thickness was visually observed, in the same manner as that illustrated in FIG. 5.

### Example 7

The same procedures as those in Example 1 were carried out, except that a polyimide solution had a viscosity of 500 mPa·s., and the running speed was 300 m/min.

In the thus obtained coated sheet, no interference unevenness due to the uneven thickness was visually observed.

Although there is no practical problem, streaky coating unevenness extending in the same direction as the running direction of the substrate film (lengthwise direction of the substrate film) slightly occurred.

### Example 8

The same procedures as those in Example 1 were carried out, except that the running speed was 350 m/min and the fluctuation rate of the running speed was controlled to 2.5%.

In the thus obtained coated sheet, no interference unevenness due to the uneven thickness was visually observed.

Although there is no practical problem, streaky coating unevenness extending in the same direction as the running direction of the substrate film (lengthwise direction of the substrate film) slightly occurred.

### Example 9

The same procedures as those in Example 1 were carried out, except that a polyimide solution had a viscosity of 2000 mPa·s., and the fluctuation rate of the running speed was controlled to 2.5%.

In the thus obtained coated sheet, no interference unevenness due to the uneven thickness was visually observed.

Although there is no practical problem, streaky coating unevenness extending in the same direction as the running direction of the substrate film (lengthwise direction of the substrate film) slightly occurred.

### Example 10

The same procedures as those in Example 1 were carried out, except that a polyimide solution had a viscosity of 2300 mPa·s., and the fluctuation rate of the running speed was controlled to 2.5%

Although there is no practical problem, interference unevenness due to the uneven thickness was slightly and visually observed in the thus obtained coated sheet.

Although there is no practical problem, streaky coating unevenness extending in the same direction as the running direction of the substrate film (lengthwise direction of the substrate film) slightly occurred.

### Example 11

The same procedures as those in Example 1 were carried out, except that the fluctuation rate of the running speed was controlled to 0.9%.

In the thus obtained coated sheet, no interference unevenness due to the uneven thickness was visually observed, in the same manner as that illustrated in FIG. 5.

### Example 12

A polyimide solution having a viscosity of 200 mPa·s with 10% by weight of polyimide (cf., the above formula (30), weight-average molecular weight (Mw)=140,000) dissolved in methylisobutylketone was prepared.

By the use of a die coater as a coating method, the polyimide solution was applied onto a polyethylene terephthalate film (thickness of 75 μm), which runs at a speed of 20 m/min with a fluctuation rate thereof controlled to 0.9%, and after the coating, dried at 120° C. for three minutes to provide a coated sheet with a coating layer having a thickness of 6 μm.

In the thus obtained coated sheet, no interference unevenness due to the uneven thickness was visually observed, in the same manner as that illustrated in FIG. 5.

The die coater used in Example 12 has a shape illustrated in FIG. 2 with die lips defining a leading end having a width of 0.8 mm, and a leading end portion on the downstream side of the substrate film being rounded or subjected to R-processing with a radius of 0.5 mm.

### Example 13

The same procedures as those in Example 12 were carried out, except that the thickness of the dried coating layer was 3 μm.

In the thus obtained coated sheet, no interference unevenness due to the uneven thickness was visually observed, in the same manner as that illustrated in FIG. 5.

### Comparative Example 1

The same procedures as those in Example 1 were carried out, except that the fluctuation rate of the running speed was controlled to 3.5%.

A photograph of a coated sheet in plan thus obtained in Comparative Example 1 is illustrated in FIG. 6. An arrow of FIG. 6 represents the running direction of a substrate film.

In the thus obtained coated sheet, streaky interference unevenness in the widthwise direction of the coated sheet (a direction orthogonal to the running direction of the substrate film) due to the uneven thickness was visually observed, as illustrated in FIG. 6.

### Comparative Example 2

The same procedures as those in Example 13 were carried out, except that the fluctuation rate of the running speed was controlled to 5.2%.

In the thus obtained coated sheet, interference unevenness due to the uneven thickness was visually observed, in the same manner as that illustrated in FIG. 6.

### Comparative Example 3

The same procedures as those in Example 1 were carried out, except that the running speed was 5 m/min and the fluctuation rate of the running speed was controlled to 5.0%

In the thus obtained coated sheet, interference unevenness in the widthwise direction of the coated sheet due to the uneven thickness was visually observed.

Reduction of the running speed makes it difficult to control the fluctuation rate of the running speed of the substrate to not more than 3%, causing unstabilized formation of beads between the die and the substrate film. As a result, interference unevenness due to the uneven thickness was caused in the coated sheet.

### Comparative Example 4

The same procedures as those in Example 1 were carried out, except that a polyimide solution had a viscosity of 40 mPa·s., and the fluctuation rate of the running speed was controlled to 2.5%

Reduction of the viscosity of the polyimide solution caused random drying unevenness after drying, and hence caused random interference unevenness.

### Comparative Example 5

The same procedures as those in Example 1 were carried out, except that a polyimide solution had a viscosity of 9000 mPa·s., the thickness of a coating layer was 22 μm, and the fluctuation rate of the running speed was controlled to 2.5%.

The surface of the coated sheet was roughened with a great surface irregularity.

The viscosities of the polyimide solutions, the running speeds and the fluctuation rates of the running speeds, etc., used in the examples and the comparative examples are collectively set forth in Table 1.

TABLE 1

| | Viscosity of | | Fluctuation | Coat | Leading |
|---|---|---|---|---|---|
| | Polyimide | Running | Rate of | thick- | End Shape |
| | Solution | Speed | Running | ness | of Die |
| | (mPa · s.) | (m/min) | Speed (%) | (μm) | Coater |
| Example 1 | 200 | 20 | 2.7 | 6 | *1 |
| Example 2 | 500 | 20 | 2.7 | 6 | *1 |
| Example 3 | 1000 | 20 | 2.7 | 6 | *1 |
| Example 4 | 1500 | 20 | 2.7 | 6 | *1 |
| Example 5 | 500 | 10 | 2.7 | 6 | *1 |
| Example 6 | 500 | 150 | 2.7 | 6 | *1 |
| Example 7 | 500 | 300 | 2.7 | 6 | *1 |
| Example 8 | 200 | 350 | 2.5 | 6 | *1 |
| Example 9 | 2000 | 20 | 2.5 | 6 | *1 |
| Example 10 | 2300 | 20 | 2.5 | 6 | *1 |
| Example 11 | 200 | 20 | 0.9 | 6 | *1 |
| Example 12 | 200 | 20 | 0.9 | 6 | *2 |
| Example 13 | 200 | 20 | 0.9 | 3 | *2 |
| Comparative | 200 | 20 | 3.5 | 6 | *1 |
| Example 1 | | | | | |
| Comparative | 200 | 20 | 5.2 | 3 | *2 |
| Example 2 | | | | | |
| Comparative | 200 | 5 | 5.0 | 6 | *1 |
| Example 3 | | | | | |
| Comparative | 40 | 20 | 2.5 | 6 | *1 |
| Example 4 | | | | | |
| Comparative | 9000 | 20 | 2.5 | 22 | *1 |
| Example 5 | | | | | |

*1: The leading end of each die lip has a width of 0.8 mm and both the inner leading end portions of the die coater are not subjected to R-processing.
*2: The die coater used has the leading end of each die lip having a width of 0.8 mm and has inner leading end portions both subjected to R-processing (a radius of 0.5 mm)

In Examples 1-13, an evenly coated sheet having no interference unevenness due to the uneven thickness was obtained.

1. A method of manufacturing a coated sheet, comprising an application step of applying a coating liquid containing a resin material and a solvent onto a substrate film that is continuously running, and a drying step of drying a coating layer applied onto the substrate film by the application step, wherein the viscosity of the coating liquid is from 70 to 8000 mPa·s, and the fluctuation rate of the running speed of the substrate film in the application step is controlled to be not more than 3.0%.

2. The method of manufacturing a coated sheet according to claim 1, wherein the viscosity of the coating liquid is from 100 to 2000 mPa·s.

3. The method of manufacturing a coated sheet according to claim 1, wherein the running speed is from 10 to 300 m/min.

4. The method of manufacturing a coated sheet according to any claim 1, wherein a die coater is used as a device for applying the coating liquid onto the substrate film.

5. The method of manufacturing a coated sheet according to claim 4, wherein the die coater has a pair of die lips and an inner leading end portion of at least one of the die lips being rounded with a radius of from 0.2 to 1.0 mm.

6. The method of manufacturing a coated sheet according to claim 1, wherein the resin material is at least one selected from the group consisting of polyamide, polyimide, polyester, polyetherketone, polyamide-imide and polyester-imide.

7. The method of manufacturing a coated sheet according to claim 1, wherein the thickness of the dried coating layer is not more than 30 μm.

8. A coated sheet manufactured by the coated sheet manufacturing method of claim 1.

9. A polarizing plate comprising a laminate of at least one coated sheet of claim 8.

10. An optical element comprising the coated sheet of claim 8.

11. An image display device comprising the optical element of claim 10.

12. An optical element comprising the polarizing plate of claim 9.
